(19) United States
(12) Patent Application Publication
(10) Pub. No.: US 2008/0100652 A1
(43) Pub. Date: May 1, 2008

(54) LIQUID JET APPARATUS AND PRINTING APPARATUS

(75) Inventors: Atsushi OSHIMA, Shiojiri-shi (JP); Kunio TABATA, Shiojiri-shi (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 11/923,448

(22) Filed: Oct. 24, 2007

(30) Foreign Application Priority Data
Oct. 25, 2006 (JP) 2006-290325
Oct. 12, 2007 (JP) 2007-266241

(51) Int. Cl. B41J 29/38

(52) U.S. Cl. 347/10

(57) ABSTRACT

This invention provides a liquid jet apparatus including: a plurality of nozzles provided at a liquid jet head; an actuator provided corresponding to the nozzles; a driving part that applies a drive signal to the actuator, wherein the driving part includes: a drive waveform signal generating circuit that generates a drive waveform signal to be a reference of a signal controlling the driving of actuator; a modulation circuit that performs a pulse modulation of the drive waveform signal generated in the drive waveform signal generating circuit; a digital power amplifier that performs a power amplification of the modulation signal having been subject to the pulse modulation in the modulation circuit; a smoothing filter that smoothes a power amplification modulation signal having been subject to the power amplification in the digital power amplifier and supplies to the actuator as the drive signal; and a modulation signal correcting part that corrects the modulation signal in accordance with power supply voltage to the digital power amplifier.

### BACKGROUND

1. Technical Field

The present invention relates to a printing device to print predetermined letter or image by producing a jet of minute liquid from a plurality of nozzles to form the particulate (dot) thereof on a print medium.

2. Related Art

With an ink-jet printer as one of such printing apparatuses, a color print can be easily obtained in general at a low price and with high quality. Accordingly, there has been widely spread to not only offices but also general users, following the popularization of personal computer, digital camera and so on.

Further in the recent ink-jet printer, the printing with high tone is required. Tone is the state of the density of each color included in the pixel indicated by liquid dot. The size of liquid dot corresponding to the density of each color is called gradient and the number of gradients that can be expressed by the liquid dot is called tone number. High tone means a large tone number. So as to change the gradient, it is necessary to change a drive pulse to an actuator provided on a liquid jet head. When the actuator is a piezoelectric device, the amount of displacement (distortion) of the piezoelectric device (more correctly, vibrating plate) becomes large with the increase of voltage applied to the piezoelectric device. Accordingly, the gradient of the liquid dot can be changed by using this.

Then in JP-A-10-81013, a drive signal is generated by connecting by combining a plurality of drive pulses with different voltage crest values to output this commonly to the piezoelectric device of nozzle with the same color provided on the liquid jet head. Among these, the drive pulse corresponding to the gradient of the liquid dot to be formed is selected according to the nozzles and the selected drive pulse is supplied to the piezoelectric device of the corresponding nozzle to produce a jet of liquid with different weights. Thereby the desired gradient of liquid dot is achieved.

The generating method of the drive signal (or drive pulse) is described in FIG. 2 of JP-A-2004-306434. In other words, data is read out from the memory with the data of drive signal stored to convert into analog data by a D/A converter and to supply the drive signal to the liquid jet head through a voltage amplifier and a current amplifier. The circuit configuration of the current amplifier is configured by a transistor with push-pull connection as shown in FIG. 3 of JP-A-2004-306434, to amplify the drive signal by so-called linear driving. In the current amplifier with such a configuration, however, the linear driving itself in a transistor is low efficiency and it is necessary to use a large scale transistor as the countermeasure of heat generation from the transistor itself. Moreover, a cooling radiator plate for transistor is also required. This leads to a disadvantage of the increase of circuit size and especially the increased size of the cooling radiator plate becomes a major obstacle in terms of layout.

To overcome this disadvantage, there can be considered about using a digital power amplifier, i.e., a class D amplifier for amplified output of drive signal. The digital power amplifier is more excellent in power amplification efficiency than in an analog power amplifier, has little power loss and can cope with high-speed rising edge or trailing edge of the drive signal. However, when the drive signal is amplified by using the digital power amplifier, the voltage value of the output drive signal changes with the change of power supply voltage. Then in the ink-jet printer described in JP-A-2005-329710, correction is performed by returning the output drive signal, namely, by applying so-called feedback.

In the method of feeding back the drive signal, however, parts such as D/A converter to generate an analog signal to be compared with the fed back drive signal and feedback circuit are required to increase the number of parts and the cost. Since the drive signal generated by a pulse modulator, a digital power amplifier and a smoothing filter is fed back, the correction cannot follow the rapid change of power supply voltage. In addition, since the phase of drive signal changes according to the number of actuators to be driven, a filter with a single phase characteristic cannot cope with the phase change of the drive signal to be fed back.

### SUMMARY

An object of the invention is to provide a liquid jet apparatus and printing apparatus capable of reducing and preventing the change of voltage value of the drive signal due to the change of power supply voltage while reducing and preventing the increases of the number of parts and the cost.

There is provided a liquid jet apparatus including: a plurality of nozzles provided at a liquid jet head; an actuator provided corresponding to the nozzles; a driving part that applies a drive signal to the actuator, wherein the driving part includes: a drive waveform signal generating circuit that generates a drive waveform signal to be a reference of a signal controlling the driving of actuator; a modulation circuit that performs a pulse modulation of the drive waveform signal generated in the drive waveform signal generating circuit; a digital power amplifier that performs a power amplification of the modulation signal having been subject to the pulse modulation in the modulation circuit; a smoothing filter that smoothes a power amplification modulation signal having been subject to the power amplification in the digital power amplifier and supplies to the actuator as the drive signal; and a modulation signal correcting part that corrects the modulation signal in accordance with power supply voltage to the digital power amplifier.

According to the liquid jet apparatus in the invention as described above, the filter characteristic of the smoothing filter is to be capable of smoothing only the power amplification modulation signal component sufficiently, and thereby high-speed rising edge and trailing edge of the drive signal to the actuator can be achieved. At the same time, since the drive signal can be subject to power amplification efficiently by the digital power amplifier with little power loss, a cooling part such as cooling radiator plate is not required.

In addition, since the modulation signal is corrected according to the power supply voltage to the digital power amplifier, the change of the voltage value of the drive signal due to the change of the power supply voltage to the digital power amplifier can be reduced and prevented while reducing and preventing the increases of the number of parts and the cost.

It is desirable that the modulation signal correcting part includes: a power supply voltage detecting part that detects the power supply voltage to the digital power amplifier; and a drive waveform signal correcting part that corrects the drive waveform signal generated in the drive waveform signal generating circuit, based on the power supply voltage detected in the power supply voltage detecting part.

In addition, it is desirable that the modulation signal correcting part includes: a power supply voltage detecting part that detects the power supply voltage to the digital power amplifier; and a triangular wave signal correcting part that corrects an oscillation of triangular wave signal for the pulse modulation, based on the power supply voltage detected in the power supply voltage detecting part.

According to the liquid jet apparatus in the invention as described above, the change of the voltage value of the drive signal due to the change of the power supply voltage to the digital power amplifier can be reduced and prevented reliably.

Further, it is desirable that the modulation signal correcting part includes: a variable power supply voltage calculating part that calculates variable power supply voltage to the digital power amplifier, based on the number of actuators to be driven; and a drive waveform signal correcting part that corrects the drive waveform signal generated in the drive waveform signal generating circuit, based on the variable power supply voltage calculated in the variable power supply voltage calculating part.

In addition, it is desirable that the modulation signal correcting part includes: a variable power supply voltage calculating part that calculates variable power supply voltage to the digital power amplifier, based on the number of actuators to be driven; and a triangular wave signal correcting part that corrects an oscillation of triangular wave signal for the pulse modulation, based on the variable power supply voltage calculated in the variable power supply voltage calculating part.

According to the liquid jet apparatus in the invention as described above, the change of the voltage value of the drive signal due to the rapid change of the power supply voltage to the digital power amplifier can be reduced and prevented reliably.

In addition, it is desirable that a printing apparatus according to the invention is the printing apparatus including the aforementioned liquid jet apparatus.

According to the printing apparatus in the invention as described above, the filter characteristic of the smoothing filter is to be capable of smoothing only the power amplification modulation signal component sufficiently, and thereby high-speed rising edge and trailing edge of the drive signal to the actuator can be achieved. At the same time, since the drive signal can be subject to power amplification efficiently by the digital power amplifier with little power loss, a cooling part such as cooling radiator plate is not required and power loss can be reduced to achieve power saving. Also, a plurality of liquid jet heads can be efficiently arranged and thereby the printing apparatus can be downsized.

In addition, since the modulation signal is corrected according to the power supply voltage to the digital power amplifier, the change of the voltage value of the drive signal due to the change of the power supply voltage to the digital power amplifier can be reduced and prevented while reducing and preventing the increases of the number of parts and the cost.

### BRIEF DESCRIPTION OF THE DRAWINGS

FIG. 1 is a skeleton framework showing an embodiment of a line head printing apparatus to which a liquid jet apparatus according to an embodiment is applied, in which FIG. 1A is a plan view and FIG. 1B is a front view.

FIG. 2 is a block configuration diagram of a controlling apparatus of the printing apparatus in FIG. 1.

FIG. 3 is a block configuration diagram of a drive waveform signal generating circuit in FIG. 2.

FIG. 4 is an explanatory diagram of a waveform memory in FIG. 3.

FIG. 5 is an explanatory diagram of a drive waveform signal generation.

FIG. 6 is an explanatory diagram of the drive waveform signal or a drive signal with time-series connection.

FIG. 7 is a block configuration diagram of a drive signal output circuit.

FIG. 8 is a block diagram of selecting part to connect the drive signal to an actuator.

FIG. 9 is a block diagram showing details of a modulation circuit, a digital power amplifier and a smoothing filter of the drive signal output circuit in FIG. 7.

FIG. 10 is an explanatory diagram of an operation of the modulation circuit in FIG. 9.

FIG. 11 is an explanatory diagram of an operation of the digital power amplifier in FIG. 9.

FIG. 12 is an explanatory diagram of a change of voltage value of the drive signal due to a change of power supply voltage.

FIG. 13 is a block diagram showing the modulation circuit in a first embodiment.

FIG. 14 is an explanatory diagram of a drive waveform signal, a triangular wave signal and a modulation signal from the modulation circuit in FIG. 13.

FIG. 15 is a block diagram showing the modulation circuit in a second embodiment.

FIG. 16 is an explanatory diagram of a drive waveform signal, a triangular wave signal and a modulation signal from the modulation circuit in FIG. 15.

FIG. 17 is a block diagram showing the modulation circuit in a third embodiment.

FIG. 18 is an explanatory diagram of a variable power supply voltage due to a change of number of driving actuators.

FIG. 19 is a flowchart showing an example of arithmetic processing performed in an arithmetic circuit.

FIG. 20 is a block diagram showing the modulation circuit in a fourth embodiment.

### DETAILED DESCRIPTION OF EXEMPLARY EMBODIMENTS

Hereinafter, a first embodiment of the invention will be described in reference to drawings.

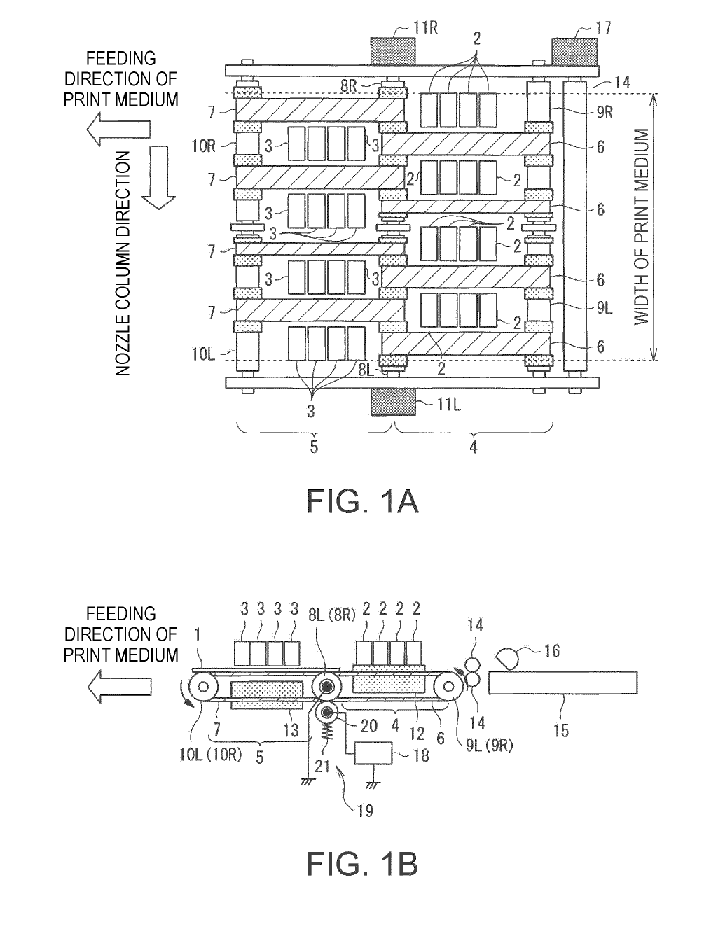

FIG. 1 is a skeleton framework showing a printing apparatus according to the first embodiment, in which FIG. 1A is a plan view and FIG. 1B is a front view. FIG. 1 indicates a line head printing apparatus, in which a print medium 1 is fed in the direction of arrow in the Figure from right to left in the Figure and printed in a printing area on the way during feeding. Note that a liquid jet head in the first embodiment is arranged at not only one area but also separately into two areas.

In Figure, a numeral 2 indicates a first liquid jet head provided on the upstream in the direction of feeding of the print medium 1 while a numeral 3 indicates a second liquid jet head provided on the downstream thereof. A first feeding part 4 to feed the print medium 1 is provided under the first liquid jet head 2 while a second feeding part 5 is provided under the second liquid jet head 3. The first feeding part 4 is configured by four first handler belts 6 arranged at predetermined intervals in the direction crossing the feeding direction of the print medium 1 (hereafter, also referred to as nozzle column direction) while the second feeding part 5 is configured by four second handler belts 7 arranged at predetermined intervals in the direction crossing the feeding direction of the print medium 1 (nozzle column direction).

The four first handler belts 6 are alternately arranged to be adjacent to the four second handler belts 7 with each other. In the first embodiment, there are separated into respective two of the first handler belts 6 and second handler belts 7 on the right sides in the nozzle column direction and respective two of the first handler belts 6 and second handler belts 7 on the left sides in the nozzle column direction, among these handler belts 6 and 7. In other words, a right-side driving roller 8R is arranged at an overlapping part of the respective two of the first handler belts 6 and second handler belts 7 on the right sides in the nozzle column direction, while a left-side driving roller 8L is arranged at an overlapping part of the respective two of the first handler belts 6 and second handler belts 7 on the left sides in the nozzle column direction. A right-side first driven roller 9R and a left-side first driven roller 9L are arranged on the upstream side therefrom while a right-side second driven roller 10R and a left-side second driven roller 10L are arranged on the downstream side therefrom. These rollers, which seem to be successive, are substantially separated at the center of FIG. 1A. The two of the first handler belts 6 on the right side in the nozzle column direction are wound around the right-side driving roller 8R and the right-side first driven roller 9R, while the two of the first handler belts 6 on the left side in the nozzle column direction are wound around the left-side driving roller 8L and the left-side first driven roller 9L. The two of the second handler belts 7 on the right side in the nozzle column direction are wound around the right-side driving roller 8R and the right-side second driven roller 10R, while the two of the second handler belts 7 on the left side in the nozzle column direction are wound around the left-side driving roller 8L and the left-side second driven roller 10L. A right-side electric motor 11R is connected to the right-side driving roller 8R while a left-side electric motor 11L is connected to the left-side driving roller 8L. Therefore, when the right-side driving roller 8R is revolved and driven by the right-side electric motor 11R, the first feeding part 4 configured by the two of the first handler belts 6 on the right side in the nozzle column direction and the second feeding part 5 configured by the two of the second handler belts 7 on the right side in the nozzle column direction are synchronized with each other and move at the same speed. When the left-side driving roller 8L is revolved and driven by the left-side electric motor 11L, the first feeding part 4 configured by the two of the first handler belts 6 on the left side in the nozzle column direction and the second feeding part 5 configured by the two of the second handler belts 7 on the left side in the nozzle column direction are synchronized with each other and move at the same speed. However, when the revolving speeds of the right-side electric motor 11R and the left-side electric motor 11L are different, the feeding speeds on the right and left in the nozzle column direction can be changed. More specifically, when the revolving speed of the right-side electric motor 11R is higher than the revolving speed of the left-side electric motor 11L, the feeding speed on the right side in the nozzle column direction can be set to be higher than that on the left side. When the revolving speed of the left-side electric motor 11L is higher than the revolving speed of the right-side electric motor 11R, the feeding speed on the left side in the nozzle column direction can be set to be higher than that on the right side.

The first liquid jet head 2 and the second liquid jet head 3 are arranged shifted in the feeding direction of the print medium 1 in units of colors, for example, yellow (Y) magenta (M), cyan (C) and black (K). Liquid is supplied to each liquid jet head 2, 3 from liquid tanks of each color (not shown) through liquid supply tubes. At each liquid jet head 2, 3, a plurality of nozzles are formed in the direction crossing the feeding direction of the print medium 1 (i.e., nozzle column direction) and producing a jet of liquid at a required amount on the necessary part from these nozzles at the same time forms a minute liquid dot on the print medium 1. Performing this in the unit of color makes it possible to print by 1 path only by passing once the print medium 1 fed on the first feeding part 4 and the second feeding part 5. In other words, arranging areas of these liquid jet heads 2, 3 correspond to a printing area.

As the method of producing a jet of liquid from each nozzle of the liquid jet head, static method, piezoelectric method, film boiling jet method and so on can be exemplified. In the static method, when the drive signal is given to a static gap as an actuator, a vibrating plate in a cavity is displaced to generate a pressure change in the cavity and the jet of liquid is produced from the nozzle by the pressure change. In the piezoelectric method, when the drive signal is given to a piezoelectric device as an actuator, a vibrating plate in a cavity is displaced to generate a pressure change in the cavity and the jet of liquid is produced from the nozzle by the pressure change. In the film boiling jet method, there is a micro heater in a cavity and liquid is turned into a film boiling state with the instantaneous heating at 300° C. or higher to generate air bubble and the jet of liquid is produced from the nozzle by the pressure change. In the invention, although either liquid jet method is applicable, the invention is preferable especially to the piezoelectric device in which the amount of producing a jet of liquid can be adjusted by adjusting the crest value of drive signal or the inclination of increase and decrease of voltage.

The nozzle for liquid jet of the first liquid jet head 2 is formed only among the four first handler belts 6 of the first feeding part 4 while the nozzle for liquid jet of the second liquid jet head 3 is formed only among the four second handler belts 7 of the second feeding part 5. This is for the cleaning of each liquid jet head 2, 3 by a cleaning part described later. With this, only one of the liquid jet heads cannot achieve a full print by 1 path. For this reason, the first liquid jet head 2 and the second liquid jet head 3 are arranged shifted in the feeding direction of the print medium 1 so as to cover the part that cannot be printed only by one part thereof.

A first cleaning cap 12 to clean the first liquid jet head 2 is arranged under the first liquid jet head 2 while a second cleaning cap 13 to clean the second liquid jet head 3 is arranged under the second liquid jet head 3. Each cleaning cap 12, 13 is formed at the size with which they can pass between the four first handler belts 6 of the first feeding part 4 and between the four second handler belts 7 of the second feeding part 5. These cleaning caps 12, 13 are configured by, for example: a square and bottomed cap body covering the nozzle formed on the lower surface of the liquid jet heads 2, 3, i.e., the nozzle surface and capable of sticking to the nozzle surface; a liquid absorber arranged at the bottom thereof; a tube pump connected to the bottom of the cap body; and a lifting and lowering device lifting and lowering the cap body. The cap body is lifted by the lifting and lowering device and stuck to the nozzle surfaces of the liquid jet heads 2, 3. In this state, when the inside of the cap body is set at negative pressure by the tube pump, liquid and air bubble are pumped from the nozzles established on the nozzle surfaces of the liquid jet heads 2, 3, which can be cleaned. After the completion of cleaning, the cleaning caps 12, 13 are lowered.

On the upstream of the first driven rollers 9R, 9L, a dyad gate roller 14 that adjusts the timing of feeding the print medium 1 supplied from the feeding part 15 and corrects a skew of the print medium 1 is provided. Skew is the distortion of the print medium 1 with regard to the feeding direction. On the upper side of the feeding part 15, a pickup roller 16 to supply the print medium 1 is provided. It should be noted that a numeral 17 in the Figure indicates a gate roller motor to drive the gate roller 14.

On the lower side of the driving rollers 8R, 8L, a belt charging apparatus 19 is provided. The belt charging apparatus 19 is configured by: a charging roller 20 contacting the first handler belts 6 and the second handler belts 7 sandwiching the driving rollers 8R, 8L; a spring 21 pressing the charging roller 20 against the first handler belts 6 and the second handler belts 7; and a power supply 18 giving an electric charge to the charging roller 20, and takes charge by making the charging roller 20 give an electric charge to the first handler belts 6 and the second handler belts 7. In general, these belts as described above are configured by medium/high resistor or insulator. Accordingly, when they take charge by the belt charging apparatus 19, the electric charge applied on the surface thereof generates dielectric polarization on the print medium 1 similarly configured by high resistor or insulator. The electrostatic force generated between the electric charge generated by the dielectric polarization and the electric charge on the belt surface can stick the print medium 1. In addition, as the belt charging apparatus 19, corotron making an electric charge descend is applicable.

Therefore, according to this printing apparatus, charging the surfaces of the first handler belts 6 and second handler belts 7 by the belt charging apparatus 19, feeding the print medium 1 from the gate roller 14 in the state, and pressing the print medium 1 against the first handler belts 6 by a paperweight roller configured by a spur and a roller (not shown) the print medium 1 is stuck to the surface of the first handler belts 6 with the operation of the aforementioned dielectric polarization. In this state, when the driving rollers 8R, 8L are subject to rotary drive by the electric motors 11P, 11L, the rotary drive force is transmitted to the first driven rollers 9R, 9L through the first handler belts 6.

Moving the first handler belts 6 toward the downstream in the feeding direction in the state of sticking the print medium 1 and moving the print medium 1 to the lower part of the first liquid jet head 2, printing is performed by producing a jet of liquid from the nozzle formed at the first liquid jet head 2. After the completion of printing by the first liquid jet head 2, the print medium 1 is moved toward the downstream in the feeding direction and put on the second handler belts 7 in the second feeding part 5. As described above, since the second handler belts 7 also have the surfaces charged by the belt charging apparatus 19, the print medium 1 is stuck to the surface of the second handler belts 7 with the operation of the aforementioned dielectric polarization.

Moving the second handler belts 7 toward the downstream in the feeding direction in this state and moving the print medium 1 to the lower part of the second liquid jet head 3, printing is performed by producing a jet of liquid from the nozzle formed at the second liquid jet head. After the completion of printing by the second liquid jet head, the print medium 1 is moved further toward the downstream in the feeding direction and separated from the surface of the second handler belts 7 by a separating apparatus (not shown) to eject to a paper ejection part.

When the cleanings of the first and second liquid jet heads 2, 3 are required, the first and second cleaning caps 12, 13 are lifted and the cap body is stuck to the nozzle surfaces of the first and second liquid jet heads 2, 3 as described above. In this state, the inside of the cap body is set at negative pressure, and thereby liquid and air bubble are pumped from the nozzles established on the nozzles of the first and second liquid jet heads 2, 3, by which cleaning is performed. Then the first and second cleaning caps 12, 13 are lowered.

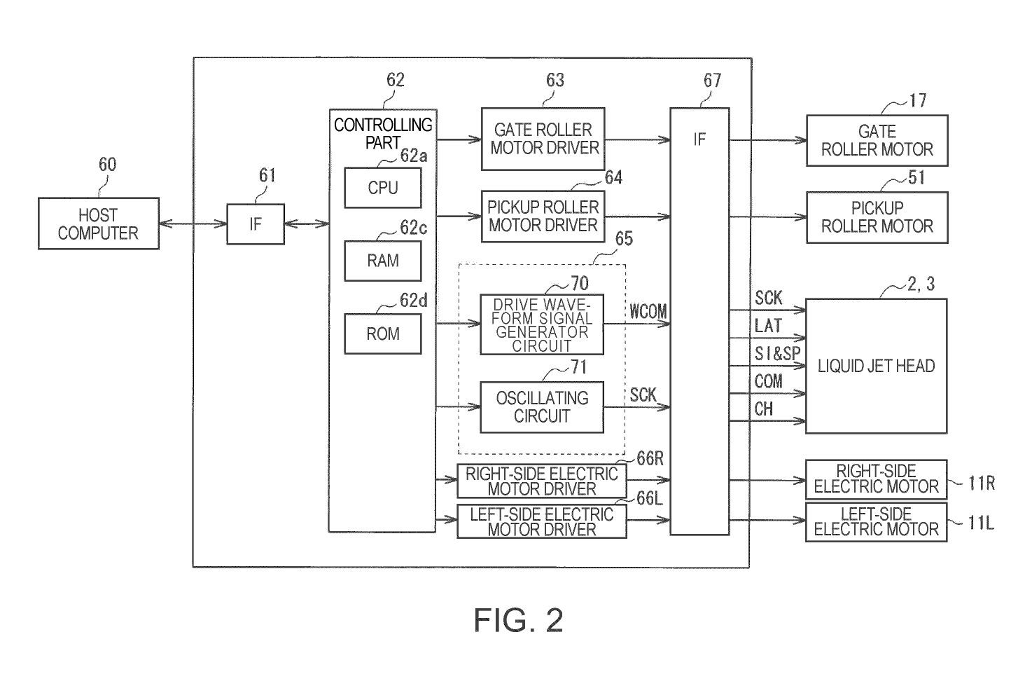

Inside the printing apparatus, a controlling apparatus to control itself is provided. This controlling apparatus performs print processing on the print medium by controlling the printing apparatus and a feeding apparatus based on the print data input from a host computer 60 such as personal computer and digital camera, as shown in FIG. 2. There is configured by: an input interface part 61 that receives the print data input from the host computer 60; a controlling part 62 that is configured by a microcomputer performing print processing based on the print data input from the input interface part 61; a gate roller motor driver 63 that drives and controls the gate roller motor 17; a pickup roller motor driver 64 that drives and controls a pickup roller motor 51 for the driving of a pickup roller 16; a head driver 65 that drives and controls the liquid jet heads 2, 3; a right-side electric motor driver 66R that controls and drives the right-side electric motor 11R; a left-side electric motor driver 66L that controls and drives the left-side electric motor 11L; and an interface 67 that converts the output signals from each of the drivers 63-65, 66R and 66L into the drive signal used in the gate roller motor 17, the pickup roller motor 51, the liquid jet heads 2, 3, the right-side electric motor 11R and the left-side electric motor 11L, each of which is located outside, and outputs.

The controlling part 62 includes: a CPU (Central Processing Unit) 62a that performs various processings such as print processing; a RAM (Random Access Memory) 62c that stores temporarily the print data input through the input interface 61 or various data in performing print processing for the print data or that develops temporarily an application program such as print processing; and a ROM (Read-Only Memory) 62d configured by nonvolatile semiconductor memory to store a control program performed in the CPU 62a. When the controlling part 62 obtains the print data (image data) from the host computer 60 through the interface part 61, the CPU 62a performs a predetermined processing on the print data and outputs printing data (drive pulse selecting data SI&SP) indicating which nozzle produces a jet of liquid or how much ink droplet is discharged, and a control signal is output to each of the drivers 63-65, 66R and 66L based on the printing data and the input data from various sensors. When the control signal is output from each of the drivers 63-65, 66R and 66L, these are converted into the drive signal in the interface part 67 and actuators corresponding to a plurality of nozzles of the liquid jet head, the gate roller motor 17, the pickup roller motor 51, the right-side electric motor 11R, the left-side electric motor 11L are activated to perform the feeding of the print medium 1, an attitude control of the print medium 1 and the print processing on the print medium 1. It should be noted that each component in the controlling part 62 is electrically connected to each other through a path (not shown).

In addition, the controlling part 62 outputs a write enable signal DEN, a write clock signal WCLK and write address data A0-A3 so as to write data DATA for waveform formation to form the drive signal described later in waveform memory 701 described later, and writes 16-bit data DATA for waveform formation in the waveform memory 701. At the same time, the controlling part 62 outputs read address data A0-A3 to read out the data DATA for waveform formation stored in the waveform memory 701, a first clock signal ACLK setting the timing of latching the data DATA for waveform formation read out from the waveform memory 701, a second clock signal BCLK setting the timing of adding the latched waveform data, and a clear signal CLER clearing latch data, to the head driver 65.

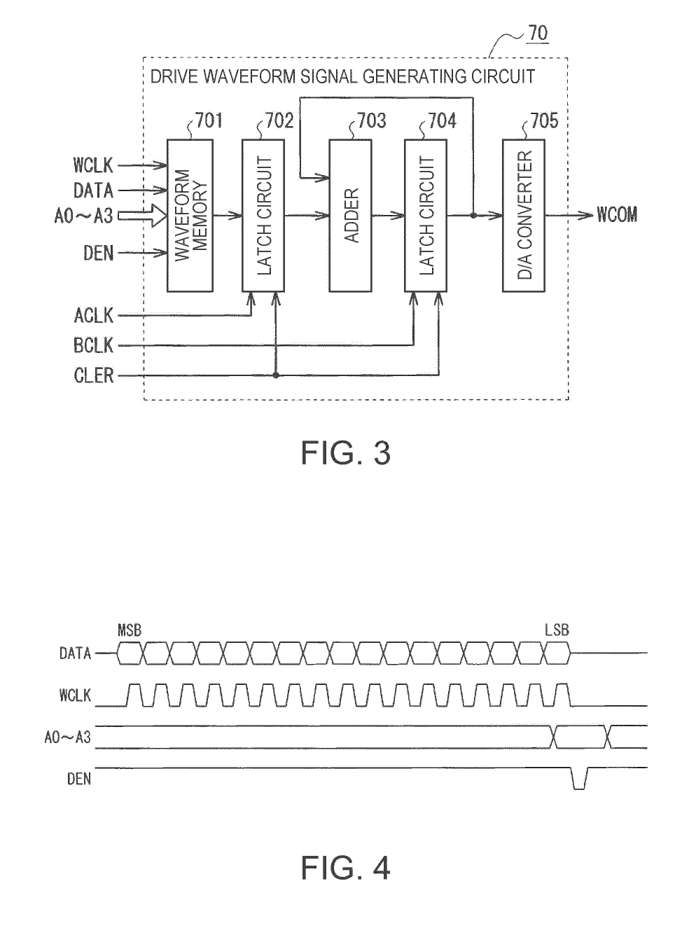

The head driver 65 includes a drive waveform signal generating circuit 70 that generates a drive waveform signal WCOM and an oscillating circuit 71 that outputs a clock signal SCK. As shown in FIG. 3, the drive waveform signal generating circuit 70 includes: the waveform 701 that stores the data DATA for waveform formation to generate the drive waveform signal input from the controlling part 62, in a memory element corresponding to a predetermined address; a latch circuit 702 that latches the data DATA for waveform formation read out from the waveform memory 701 by the aforementioned first clock signal ACLK; an adder 703 that adds the output from the latch circuit 702 to data WDATA for waveform generation output from a latch circuit 704 described later; the latch circuit 704 that latches the addition output from the adder 703 by the aforementioned second clock signal BCLK; and a D/A converter 705 that converts the data WDATA for waveform generation output from the latch circuit 704 into an analog signal. Here, a clear signal CLER output from the controlling part 62 is input to the latch circuits 702, 704 and the latch data is cleared when the clear signal CLER turns into an off-state.

The waveform memory 701, as shown in FIG. 4, has memory devices arranged by several bits in the indicated address and the waveform data DATA is stored along with the addresses A0-A3. More specifically, the waveform data DATA is input along with the clock signal WCLK with regard to the addresses A0-A3 indicated by the controlling part 62 and the waveform data DATA is stored in the memory device by the input of the write enable signal DEN.

Next, there will be described the principle of the drive waveform signal generation by the drive waveform signal generating circuit 70. First, the waveform data has been written to be 0 as the amount of voltage change per unit time in the aforementioned address A0. Similarly, the waveform data +ΔV1 is written in the address A1, the waveform data −ΔV2 is written in the address A2 and the waveform data +ΔV3 is written in the address A3. The stored data in the latch circuits 702, 704 is cleared by the clear signal CLER. In addition, the drive waveform signal WCOM is launched at a midpoint potential (offset) by the waveform data.

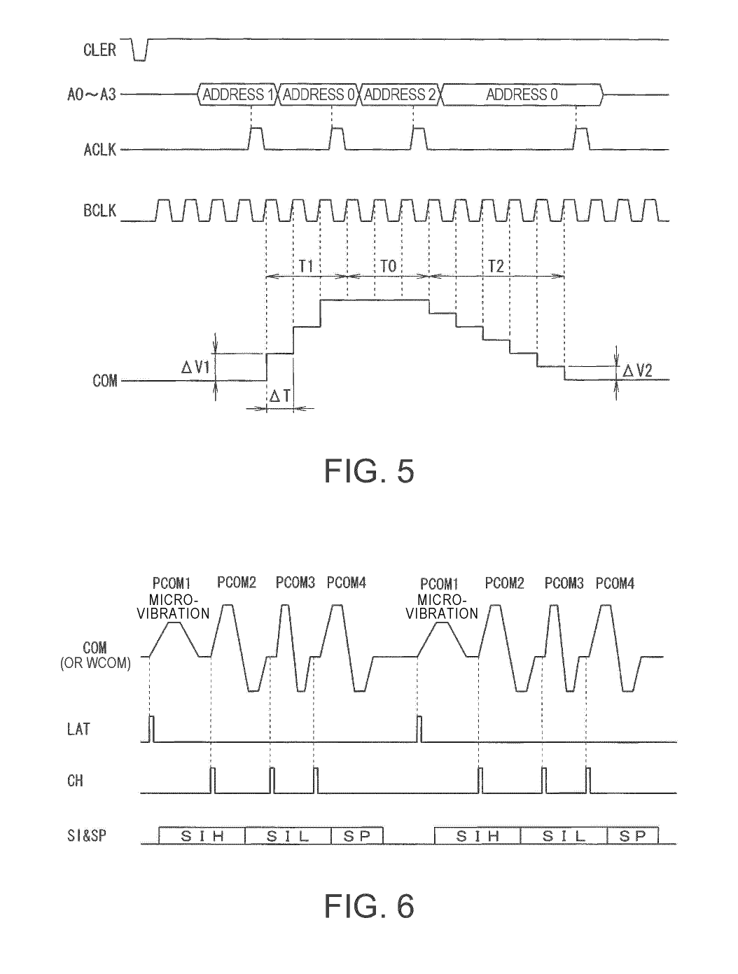

From this state, when the waveform data in the address A1 is read in as shown in, for example, FIG. 5 and the first clock signal ACLK is input, digital data of +ΔV1 is stored in the latch circuit 702. The stored digital data of +ΔV1 is input to the latch circuit 704 through the adder 703 and in the latch circuit 704 the output from the adder 703 is stored synchronized with the rising up of the second clock signal BCLK. Since the output from the latch circuit 704 is also input to the adder 703, the output from the latch circuit 704, i.e., a drive signal COM is added by +ΔV1 at the timing of rising up of the second clock signal BCLK. In this example, the waveform data in the address A1 is read during a duration T1 and as the result, there is added until the digital data of +ΔV1 is to be threefold.

When the waveform data in the address A0 is read in and the first clock signal ACLK is input, digital data to be stored in the latch circuit 702 is switched to 0. The digital data of 0 is added at the timing of rising up of the second clock signal BCLK through the adder 703 similarly to the aforementioned example. However, since the digital data is 0, the previous value is held substantially. In this example, the drive signal COM is held at a certain value during a duration T0.

When the waveform data in the address A2 is read in and the first clock signal ACLK is input, digital data to be stored in the latch circuit 702 is switched to −ΔV2. The digital data of −ΔV2 is added at the timing of rising up of the second clock signal BCLK through the adder 703 similarly to the aforementioned example. However, since the digital data is −ΔV2, the drive signal COM is subtracted by −ΔV2 according to the second clock signal substantially. In this example, the drive signal COM is subtracted during a duration T2 until the digital data of −ΔV2 is to be sixfold.

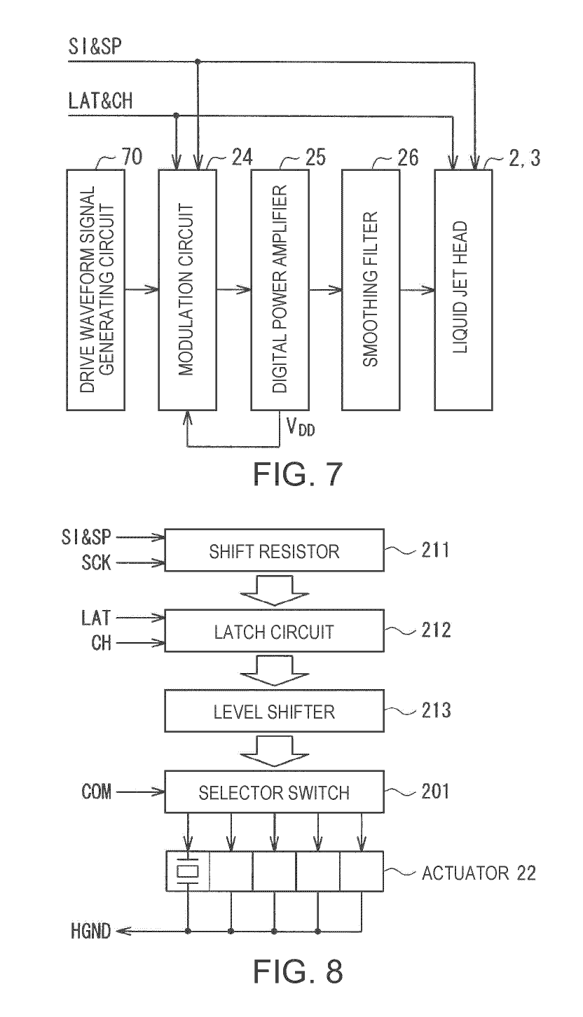

When the digital signal thus generated is subject to analog conversion by the D/A converter 705, the drive waveform signal WCOM is obtained as shown in FIG. 6. The power thereof is amplified in a drive waveform signal output circuit shown in FIG. 7 and supplied as the drive signal COM to the liquid jet heads 2, 3. Thereby the actuator provided at each nozzle can be driven and a jet of liquid can be produced from each nozzle. This drive waveform signal output circuit includes: a modulation circuit 24 that performs a pulse modulation of the drive waveform signal WCOM generated in the drive waveform signal generating circuit 70; a digital power amplifier 25 that performs a power amplification of a modulation (PWM) signal having been subject to the pulse modulation in the modulation circuit 24; and a smoothing filter 26 that smoothes the modulation (PWM) signal having been subject to the power amplification in the digital power amplifier 25.

The rising edge part of the drive signal COM is the stage of pulling liquid into by expanding the volume of the cavity (pressure chamber) communicated with the nozzle (this can be said to be pulling meniscus considering the surface of producing a jet of liquid) and the trailing edge part of the drive signal COM is the stage of extruding liquid by reducing the volume of the cavity (this can be said to be extruding meniscus considering the surface of producing a jet of liquid). As the result of extruding liquid, a jet of liquid is produced from the nozzle. After pulling the liquid into, a series of waveform signals extruding liquid as required is set to be drive pulse, and the drive signal COM is assumed to have a plurality of drive pulses connected. Incidentally, the waveform of the drive signal COM or drive waveform signal WCOM, which can be easily expected by the above description, can be adjusted by the waveform data 0, +ΔV1, −ΔV2, +ΔV3, the first clock signal ACLK, the second clock signal BCLK which are written in the addresses A0-A3. In addition, although the first clock signal ACLK is referred to as the clock signal as a matter of convenience, the output timing of signal can be freely adjusted substantially by an arithmetic processing described later.

One drive signal COM configured by voltage trapezoidal wave is set as a drive pulse PCOM to change the inclination of voltage change or the crest value of each drive pulse PCOM. Thereby the amount or speed of pulling liquid and the amount or speed of extruding liquid can be changed, and thereby the amount of producing a jet of liquid can be changed to obtain different sizes of liquid dots. Therefore, as shown in FIG. 6, a plurality of drive pulses PCOM are subject to time-series connection to generate the drive signal COM and a single drive pulse PCOM is selected to be supplied to the actuator. Then a jet of liquid is produced, a plurality of drive pulses PCOM are selected to be supplied to the actuator and a jet of liquid is produced more than once. Thereby various sizes of liquid dots can be obtained. In other words, when a plurality of liquid dots reach the same position before the liquid dries, this is substantially the same as producing a jet of liquid in large amount and the size of liquid dot can be increased. The combination of such techniques makes it possible to achieve a multiple tone. In addition, the drive pulse PCOM1 at the far left of FIG. 6 only pulls liquid into and does not extrude. This is called microvibration and used to reduce and prevent the drying of nozzle without producing a jet of liquid.

As the result of these, there are input to the liquid jet heads 2, 3: the drive signal COM generated in the drive signal output circuit; the drive pulse selecting data SI&SP that selects the nozzle to produce a jet based on the print data and determines the timing of connecting the actuator to the drive signal COM; the latch signal LAT and a channel signal CH that connect the drive signal COM to the actuators of the liquid jet heads 2, 3 based on the drive pulse selecting data SI&SP after nozzle selecting data is input to all nozzles; and the clock signal SCK to send the drive pulse selecting data SI&SP to the liquid jet heads 2, 3 as a serial signal. Hereinafter, when a plurality of drive signals COM are subject to time-series connection to be output, a single drive signal COM is set as the drive pulse PCOM and the whole signals with time-series connection of the drive pulse PCOM are indicated as the drive signal COM.

Next, there will be described the configuration of connecting the drive signal COM output from the drive signal output circuit and the actuator. FIG. 8 is a block diagram of a selecting part to connect the drive signal COM to the actuator 22 such as piezoelectric device. This selecting part is configured by: a shift resistor 211 that stores the drive pulse selecting data SI&SP to specify the actuator 22 such as piezoelectric device corresponding to the nozzle to produce a jet of liquid; a latch circuit 212 that stores the data of the shift resistor 211 temporarily; a level shifter 213 that performs a level conversion of the output from the latch circuit 212; and a selector switch 201 that connects the drive signal COM to the actuator 22 according to the output from the level shifter.

To the shift resistor 211, the drive pulse selecting data SI&SP is sequentially input and the storage area shifts from a first stage to a subsequent stage according to the input pulse of the clock signal SCK. The latch circuit 212 latches each output signal from the shift resistor 211 by the latch signal LAT to be input after the drive pulse selecting data SI&SP by the number of nozzles is stored in the shift resistor 211. The signal stored in the latch circuit 212 is converted into the voltage level capable of turning on and off the selector switch 201 at the next stage by the level shifter 213. This is because the drive signal COM has higher voltage than the output voltage from the latch circuit 212 and the range of operating voltage of the selector switch 201 is set to be high as well. Consequently, the actuator 22 having the selector switch 201 closed by the level shifter 213 is connected to the drive signal COM at the timing of connecting the drive pulse selecting data SI&SP. In addition, after the drive pulse selecting data SI&SP of the shift resistor 211 is stored in the latch circuit 212, the next drive pulse selecting data SI&SP is input to the shift resistor 211 to update the stored data in the latch circuit 212 sequentially at the timing of producing a jet of liquid. It should be noted that a numeral HGND in the Figure indicates a ground edge of the actuator 22. According to the selector switch 201, even after the actuator 22 is separated from the drive signal COM, the input voltage of the actuator 22 is maintained at the voltage immediately before the separation.

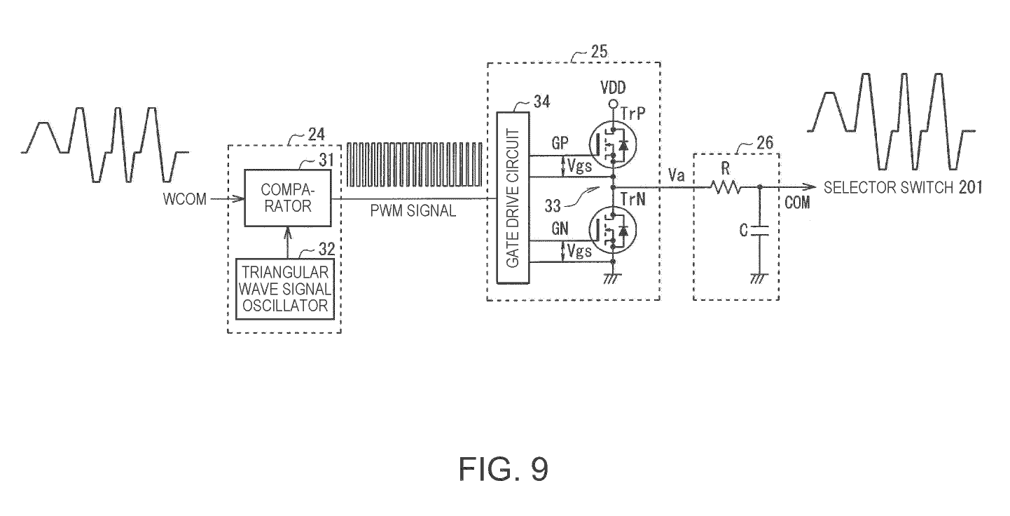

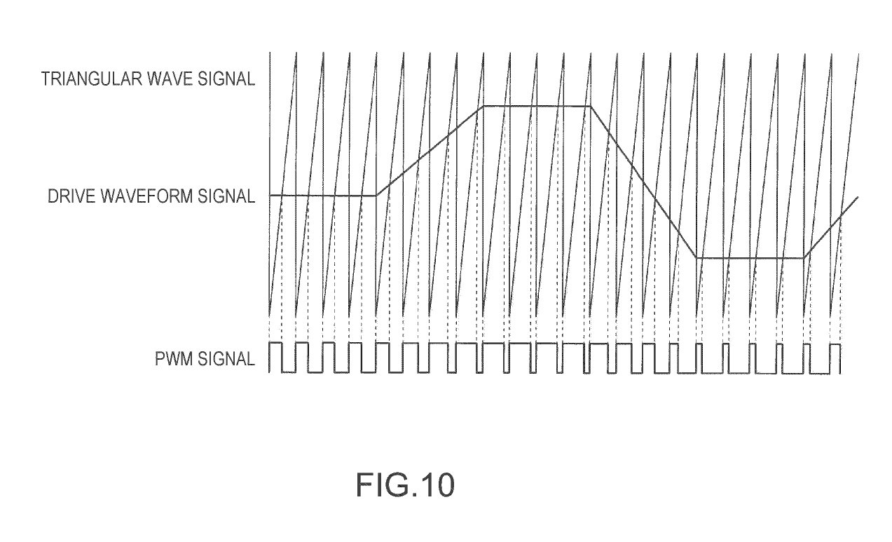

FIG. 9 shows a concrete configuration from the modulation circuit 24 to the smoothing filter 26 of the aforementioned drive signal output circuit. As the modulation circuit 24 performing pulse modulation on the drive waveform signal WCOM, a general pulse width modulation (PWM) circuit is used. This modulation circuit 24 is configured by a well-known triangular wave signal oscillator 32 and a comparator 31 that compares the triangular wave signal output from the triangular wave signal oscillator 32 with the drive waveform signal WCOM (in an actual circuit, an arithmetic circuit and a multiplier are included as will be described later). According to this modulation circuit 24, as shown in FIG. 10, there is output the modulation (PWM) signal indicated as Hi in the case where the drive waveform signal WCOM is the triangular wave signal or higher while there is output the modulation (PWM) signal indicated as Lo in the case where the drive waveform signal WCOM is lower than the triangular wave signal. In the first embodiment, in addition, although the pulse width modulation circuit is used as the modulation circuit, a pulse density modulation (PDM) circuit may be used in place of this.

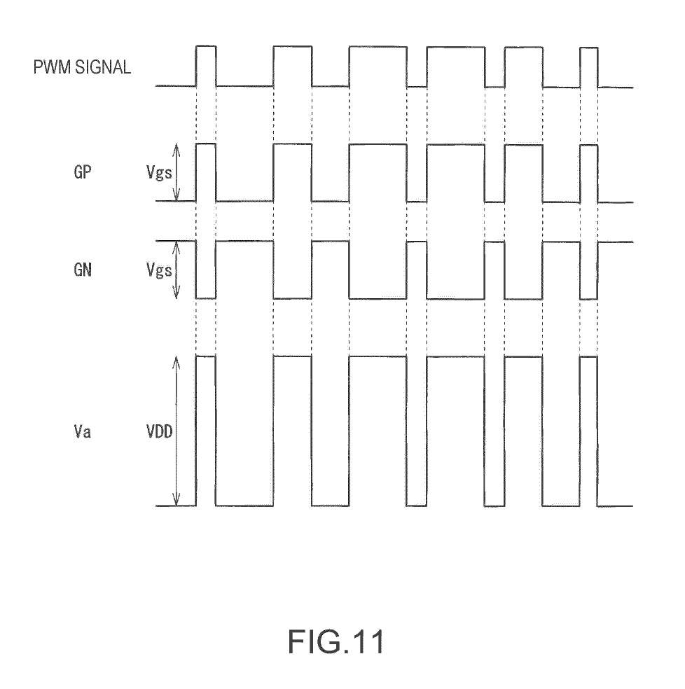

The digital power amplifier 25 is configured by a half-bridge driver stage 33 including two MOSFETTrP, TrN to amplify the power substantially, and a gate drive circuit 34 to adjust the gate-source signals GP, GN of these MOSFETTrP, TrN based on the modulation (PWM) signal from the modulation circuit 24. The half-bridge driver stage 33 has a highside MOSFETTrP and a lowside MOSFETTrN combined in a push-pull structure. In these, when the gate-source signal on the highside MOSFETTrP is set as GP while the gate-source signal on the lowside MOSFETTrN is set as GN and the output from the half-bridge driver stage 33 is set as Va, FIG. 11 shows the change of these according to the modulation (PWM) signal. It should be noted that voltage values Vgs of the gate-source signal GP, GN of MOSFETTrP, TrN have voltage values high enough to turn on those MOSFETTrP, TrN.

When the modulation (PWM) signal is at Hi level, the gate-source signal GP on the highside MOSFETTrP is at Hi level and the gate-source signal GN on the lowside MOSFETTrN is at Lo level. Accordingly, the highside MOSFETTrP is in ON state while the lowside MOSFETTrN is in OFF state. As the result, the output Va from the half-bridge driver stage 33 becomes a power supply voltage VDD. On the other hand, when the modulation (PWM) signal is at Lo level, the gate-source signal GP on the highside MOSFETTrP is at Lo level and the gate-source signal GN on the lowside MOSFETTrN is at Hi level. Accordingly, the highside MOSFETTrP is in OFF state while the lowside MOSFETTrN is in ON state. As the result, the output Va from the half-bridge driver stage 33 becomes 0.

The output Va from the half-bridge driver stage 33 of the digital power amplifying circuit 25 is supplied as the drive signal COM to the selector switch 201 through the smoothing filter 26. The smoothing filter 26 is configured by a primary RC lowpass (lowpass) filter including a combination of one resistance R and one capacitor C. The smoothing filter 26 including the lowpass filter is designed so as to attenuate sufficiently a high-frequency component of the output Va from the half-bridge driver stage 33 of the digital power amplifying circuit 25, i.e., a carrier signal component of the power amplification modification (PWM) and so as not to attenuate a drive signal component COM (or drive waveform signal component WCOM). In addition, the characteristics of the lowpass filter may be set so as to reduce the weight variation of the liquid of ink droplet due to the individual variability of nozzle or actuator 22 as required.

When the MOSFETTrP, TrN of the digital power amplifier 25 are subject to digital driving as described above, the MOSFET functions as a switch element. Accordingly, although a current flows the MOSFET in an ON-state, the resistance value between the drain and the source is very small and little power loss is generated. In addition, since a current does not flow the MOSFET in an OFF-state, a power loss is not generated. Therefore, the power loss of the digital power amplifier 25 is extremely small and a small MOSFET can be used. Further, a cooling part such as cooling radiator plate is not required. Incidentally, the efficiency of linear driving of the transistor is approximately 30% while the efficiency of the digital power amplifier is 90% or higher. The size of the cooling radiator plate of the transistor is required to have approximately 60-mm-square per transistor. Accordingly, when such a cooling radiator plate is not required, an overwhelming advantage can be obtained in terms of actual layout.

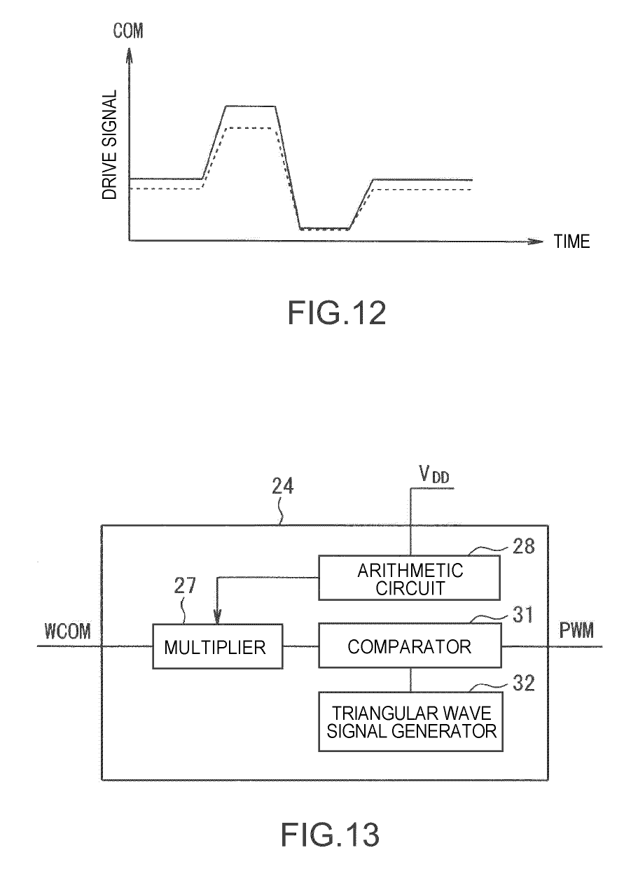

Next, the actual configuration of the modulation circuit 24 according to the first embodiment will be described. As can be guessed from the above description, in the digital power amplifier 25, the voltage value of the drive signal COM changes with the change of the power supply voltage VDD. When the voltage value of the drive signal COM is indicated as a solid line in FIG. 12 in the case where the power supply voltage VDD has a rated value, the voltage value of the drive signal COM deteriorates with the deterioration of the power supply voltage VDD as indicated by a broken line in FIG. 12. The change of the voltage value of the drive signal COM is represented as the change of the operation amount of the actuator 22 as it is. Accordingly, the weight of liquid with the jet produced changes and as the result, a desired print image quality cannot be obtained. In addition, such a change of the power supply voltage VDD cannot be avoided as long as a commercial power supply is used.

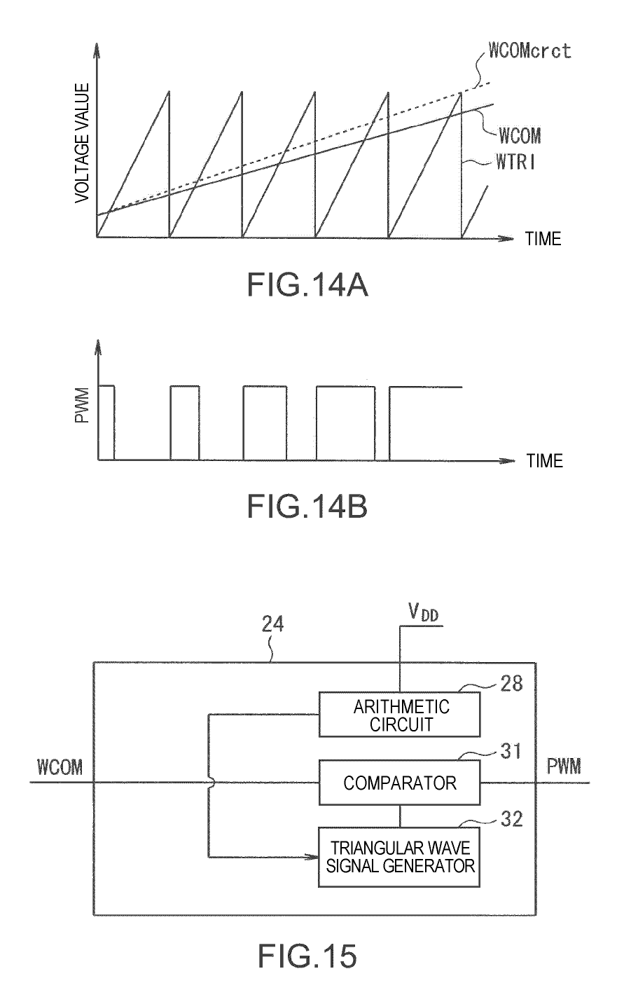

In the first embodiment, as shown in FIG. 13, a multiplier 27 is provided on the input side of the comparator 31 of the modulation circuit 24 and an arithmetic circuit 28 configured by a computer system is provided. By this arithmetic circuit 28, the power supply voltage VDD is read to adjust the gain (coefficient) of the multiplier 27. The gain is set as the value VDDstd/VDD where a predetermined power supply voltage VDDstd in design is divided by the detected power supply voltage VDD. FIG. 14A shows the voltage values of the drive waveform signal WCOM before corrected, a corrected drive waveform signal WCOMcrct corrected by multiplying WCOM by the gain VDDstd/VDD and a triangular wave signal WTRI output from the triangular wave signal generator 32. FIG. 14B shows the modulation (PWM) signal by the corrected drive waveform signal WCOMcrct and the triangular wave signal WTRI. As is clear from the Figures, the modulation signal to generate an original drive signal COM is output by correcting the drive waveform WCOM by an actual power supply voltage VDD. As a result, the voltage value of the drive signal COM can be maintained at a predetermined value to secure the weight of producing a jet of liquid.

According to the first embodiment as described above, the drive waveform signal WCOM to be a reference of a signal controlling the driving of the actuator 22 is generated in the drive waveform signal generating circuit 70. The drive waveform signal WCOM thus generated is subject to the pulse modulation in the modulation circuit 24 and the power of the modulation signal with the pulse modulation is amplified in the digital power amplifier 25. The power amplification modulation signal having been subject to the power amplification is smoothed in the smoothing filter 26 to supply as the drive signal COM to the actuator 22. Accordingly, the filter characteristic of the smoothing filter 26 is to be capable of smoothing only the power amplification modulation signal component sufficiently, and thereby high-speed rising edge and trailing edge of the drive signal COM to the actuator 22 can be achieved. At the same time, since the drive signal COM can be subject to power amplification efficiently by the digital power amplifier 25 with little power loss, a cooling part such as cooling radiator plate is not required. Thereby a plurality of liquid jet heads can be efficiently arranged and the printing apparatus can be downsized.

In addition, since the modulation signal is corrected according to the power supply voltage VDD to the digital power amplifier 25, the change of the voltage value of the drive signal COM due to the change of the power supply voltage VDD to the digital power amplifier 25 can be reduced and prevented while reducing and preventing the increases of the number of parts and the cost.

Further, since the power supply voltage VDD to the digital power amplifier 25 is detected to correct the drive waveform signal WCOM generated in the drive waveform signal generating circuit 70 based on the detected power supply voltage VDD, the change of the voltage value of the drive signal COM due to the change of the power supply voltage VDD to the digital power amplifier 25 can be reduced and prevented reliably.

Moreover, there can be built by digitalization, i.e., arithmetic processing from the drive waveform signal generating circuit 70 to the modulation circuit 24. Thereby it is advantageous in various terms of structure, cost, layout, power consumption, S-data transmission rate, heating value and so on.

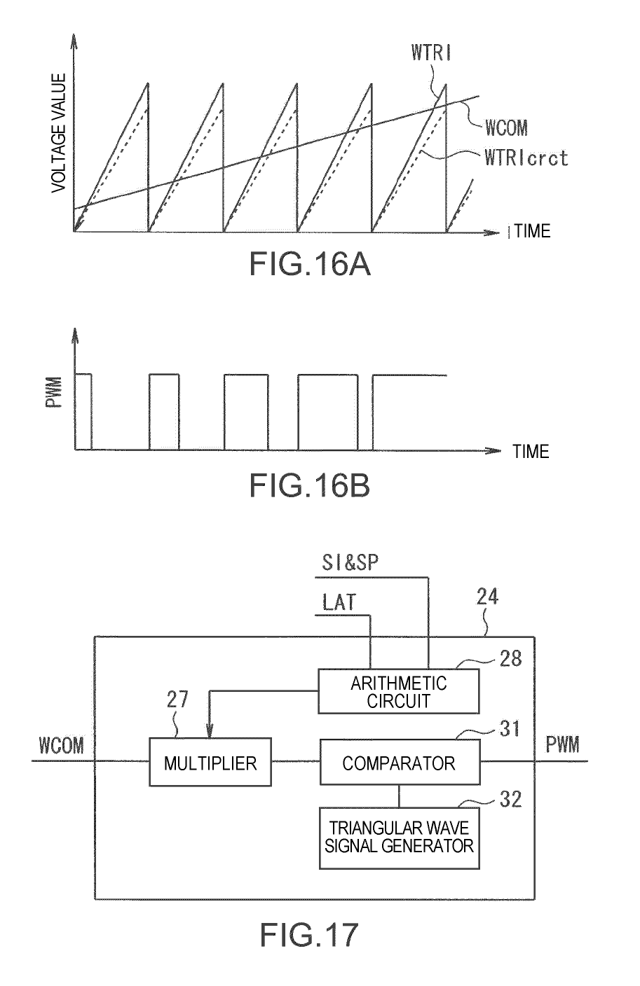

Next, the second embodiment of the invention will be described. FIG. 15 is a block diagram showing the modulation circuit 24 in the second embodiment. In the second embodiment, the multiplier in the first embodiment is removed and the power supply voltage VDD is read in the arithmetic circuit 28 to adjust the crest value, i.e., oscillation of triangular wave signal WTRI output from the triangular wave signal generator 32. Oscillation is calculated by multiplying a predetermined oscillation in design by a correction factor VDD/VDDstd calculated by dividing the detected power supply voltage VDD by a predetermined power supply voltage VDDstd in design. In configuring the triangular wave signal WTRI as digital, the value calculated by multiplying the triangular wave signal WTRI by the correction factor VDD/VDDstd is a corrected triangular wave signal WTRIcrct. FIG. 16A shows the voltage values of the triangular wave signal WTRI before corrected, the corrected triangular wave signal WTRIcrct corrected by multiplying the triangular wave signal WTRI by the correction factor VDD/VDDstd, and the drive waveform signal WCOM. FIG. 16B shows the modulation signal (PWM signal) by the drive waveform signal WCOM and the corrected triangular wave signal WTRIcrct. As is clear from the Figures, the modulation signal to generate an original drive signal COM is output by correcting the oscillation of the triangular wave signal WTRI by an actual power supply voltage VDD. As a result, the voltage value of the drive signal COM can be maintained at a predetermined value to secure the weight of producing a jet of liquid.

According to the second embodiment as described above, in addition to the advantage obtained in the first embodiment, since the power supply voltage VDD to the digital power amplifier 25 is detected to correct the oscillation of the triangular wave signal WTRI for pulse modulation based on the detected power supply voltage VDD, the change of the voltage value of the drive signal COM due to the change of the power supply voltage VDD to the digital power amplifier 25 can be reduced and prevented reliably.

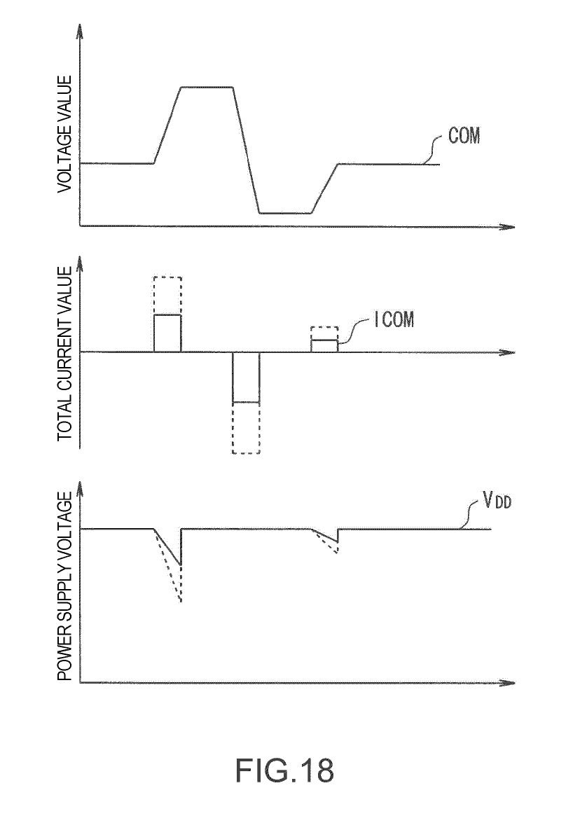

Next, the third embodiment of the invention will be described. FIG. 17 is a block diagram showing the modulation circuit 24 in the third embodiment. The configuration of the modulation circuit 24 in the third embodiment is the same as FIG. 13 in the first embodiment. However, in the arithmetic circuit 28, the drive pulse selecting data SI&SP and the latch signal LAT are read to adjust the gain of the multiplier 27 based thereon. FIG. 18 shows changes of total current value ICOM and the power supply voltage VDD of the drive signal COM according to the number of nozzles to be driven, in other words, the number of actuators to be driven. The total current value consumed in all driving actuators increases with the increase of the number of actuators to be driven. The power supply voltage VDD deteriorates even if temporarily, with the increase of the total current value. The deterioration of the power supply voltage VDD generated by the driving actuators cannot be coped with only by detecting the power supply voltage VDD to correct the modulation signal as in the first and second embodiments as described above.

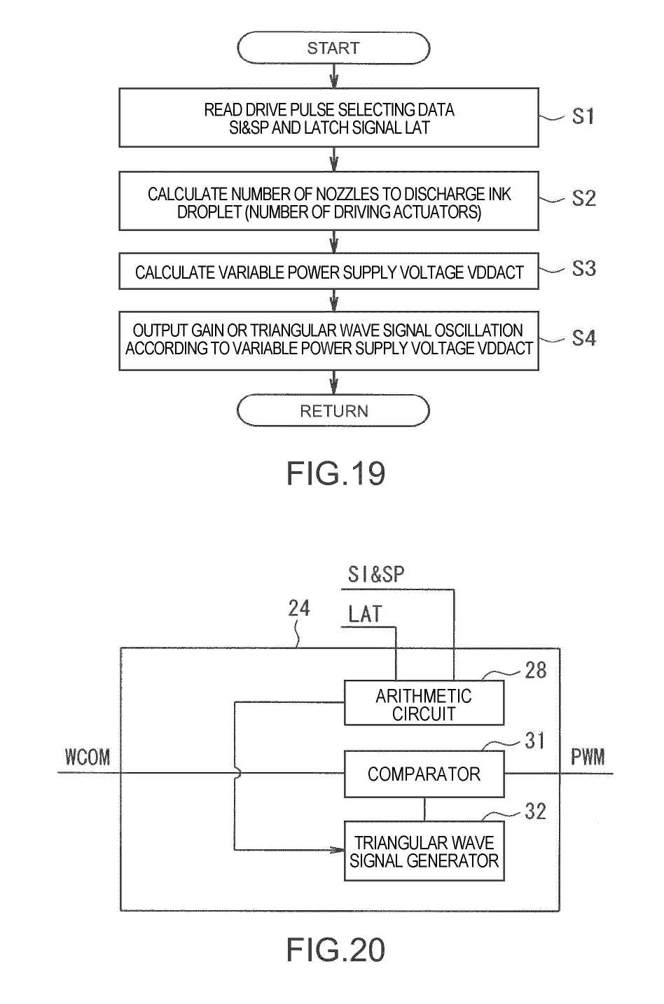

Therefore in the third embodiment, an arithmetic processing shown in FIG. 19 is performed in the arithmetic circuit 28 to calculate a variable power supply voltage VDDACT and to correct the modulation signal by using this variable power supply voltage VDDACT. In this arithmetic processing, the drive pulse selecting data SI&SP and the latch signal LAT are read in step S1 first.

Next there proceeds to step S2 to calculate the number of the actuators to be driven according to the drive pulse selecting data SI&SP and the latch signal LAT read in step S1.

Next there proceeds to step S3 to calculate the variable power supply voltage VDDACT according to the number of the actuators to be driven calculated in step S2.

Next there proceeds to step S4 to return to a main program after outputting the gain according to the variable power supply voltage VDDACT calculated in step S3, to the multiplier 27. It should be noted that the method of setting the gain is the same as in the first embodiment as described above.

According to this arithmetic processing, the number of the actuators to be driven is calculated according to the drive pulse selecting data SI&SP and the latch signal LAT, the variable power supply voltage VDDACT is calculated according to the calculated number of the actuators, and the drive waveform signal WCOM and therefore the modulation signal are corrected by outputting the gain according to the calculated variable power supply voltage VDDACT to the multiplier 27. Thereby the voltage value of the drive signal COM can be maintained at a predetermined value to secure the weight of producing a jet of liquid considering the power supply voltage VDD according to the number of the actuators to be driven.

According to the third embodiment as described above, in addition to the advantages obtained in the first and second embodiments, since the variable power supply voltage VDDACT to the digital power amplifier 25 is calculated according to the number of the actuators 22 to be driven to correct the drive waveform signal WCOM generated in the drive waveform signal generating circuit 70 based on the calculated variable power supply voltage VDDACT, the change of the voltage value of the drive signal COM due to the rapid change of the power supply voltage VDD to the digital power amplifier 25 can be reduced and prevented reliably.

Next, the fourth embodiment of the invention will be described. FIG. 20 is a block diagram showing the modulation circuit 24 in the fourth embodiment. The configuration of the modulation circuit 24 in the fourth embodiment is the same as FIG. 15 in the second embodiment. However, in the arithmetic circuit 28, the drive pulse selecting data SI&SP and the latch signal LAT are read to adjust the oscillation of triangular wave signal WTRI based thereon. More specifically, the triangular wave signal oscillation according to the variable power supply voltage VDDACT is output in step S4 of the arithmetic processing in FIG. 19 of the third embodiment as described above. The method of calculating the triangular wave signal oscillation is the same as in the second embodiment.

According to this arithmetic processing, the number of the actuators to be driven is calculated according to the drive pulse selecting data SI&SP and the latch signal LAT, the variable power supply voltage VDDACT is calculated according to the calculated number of the actuators, and the modulation signal is corrected by outputting the triangular wave signal oscillation according to the calculated variable power supply voltage VDDACT to the triangular wave signal generator 32. Thereby the voltage value of the drive signal COM can be maintained at a predetermined value to secure the weight of producing a jet of liquid considering the power supply voltage VDD according to the number of the actuators to be driven.

According to the fourth embodiment as described above, in addition to the advantages obtained in the first to third embodiments, since the variable power supply voltage VDDACT to the digital power amplifier 25 is calculated according to the number of the actuators 22 to be driven to correct the oscillation of the triangular wave signal WTRI for pulse modulation based on the calculated variable power supply voltage VDDACT, the change of the voltage value of the drive signal COM due to the rapid change of the power supply voltage VDD to the digital power amplifier 25 can be reduced and prevented reliably.

Although there has been described an example of applying the invention by targeting a line head printing apparatus, the liquid jet apparatus and the printing apparatus in the invention is applicable to various types of printing apparatus such as multipath printing apparatus printing letter or image on a print medium by producing a jet of liquid. In addition, each part configuring the liquid jet apparatus and the printing apparatus in the invention may be replaced with that with an arbitrary configuration capable of delivering similar functions or other arbitrary construct may be added.

In addition, the liquid whose jet is produced from the liquid jet apparatus in the invention is not especially restricted and the liquid including various materials as follows (including dispersion liquid such as suspension and emulsion) is applicable. In other words, there are applicable: ink including filter material of color filter; emission material to form an EL emission layer in an organic EL (Electro Luminescence) apparatus; fluorescent material to form phosphor on an electrode in an electron emission apparatus; fluorescent material to form phosphor in a PDP (Plasma Display Panel) apparatus; migrating body material to form migrating body in an electronic portal imaging device; bank material to form a bank on the surface of substrate; various kinds of coating material; liquid electrode material to form an electrode; particulate material configuring a spacer to configure a minute cell gap between two substrates; liquid metal material to form a metal wiring; lens material to form a microlens; resist material; and light diffusing material to form light diffuser.

In the invention, in addition, the print medium to be the target of producing a jet of liquid is not restricted to paper such as recording paper. Other medium such as film, woven fabric and nonwoven fabric, and work such as various substrate including glass substrate and silicon substrate are applicable.

What is claimed is:

1. A liquid jet apparatus comprising:
a plurality of nozzles provided at a liquid jet head;
an actuator provided corresponding to the nozzles;
a driving part that applies a drive signal to the actuator,
wherein the driving part includes:
a drive waveform signal generating circuit that generates a drive waveform signal to be a reference of a signal controlling the driving of actuator;
a modulation circuit that performs a pulse modulation of the drive waveform signal generated in the drive waveform signal generating circuit;
a digital power amplifier that performs a power amplification of the modulation signal having been subject to the pulse modulation in the modulation circuit;
a smoothing filter that smoothes a power amplification modulation signal having been subject to the power amplification in the digital power amplifier and supplies to the actuator as the drive signal; and
a modulation signal correcting part that corrects the modulation signal in accordance with power supply voltage to the digital power amplifier.

2. The liquid jet apparatus according to claim 1, wherein the modulation signal correcting part comprises:
a power supply voltage detecting part that detects the power supply voltage to the digital power amplifier; and
a drive waveform signal correcting part that corrects the drive waveform signal generated in the drive waveform signal generating circuit, based on the power supply voltage detected in the power supply voltage detecting part.

3. The liquid jet apparatus according to claim 1, wherein the modulation signal correcting part comprises:
a power supply voltage detecting part that detects the power supply voltage to the digital power amplifier; and
a triangular wave signal correcting part that corrects an oscillation of triangular wave signal for the pulse modulation, based on the power supply voltage detected in the power supply voltage detecting part.

4. The liquid jet apparatus according to claim 1, wherein the modulation signal correcting part comprises:
a variable power supply voltage calculating part that calculates variable power supply voltage to the digital power amplifier, based on the number of actuators to be driven; and
a drive waveform signal correcting part that corrects the drive waveform signal generated in the drive waveform signal generating circuit, based on the variable power supply voltage calculated in the variable power supply voltage calculating part.

5. The liquid jet apparatus according to claim 1, wherein the modulation signal correcting part comprises:
a variable power supply voltage calculating part that calculates variable power supply voltage to the digital power amplifier, based on the number of actuators to be driven; and
a triangular wave signal correcting part that corrects an oscillation of triangular wave signal for the pulse modulation, based on the variable power supply voltage calculated in the variable power supply voltage calculating part.

6. A printing apparatus comprising:
a feeding part that feeds a print medium;
a plurality of nozzles provided at a liquid jet head;
an actuator provided corresponding to the nozzles;
a driving part that applies a drive signal to the actuator,
wherein the driving part includes:
a drive waveform signal generating circuit that generates a drive waveform signal to be a reference of a signal controlling the driving of actuator;
a modulation circuit that performs a pulse modulation of the drive waveform signal generated in the drive waveform signal generating circuit;
a digital power amplifier that performs a power amplification of the modulation signal having been subject to the pulse modulation in the modulation circuit;
a smoothing filter that smoothes a power amplification modulation signal having been subject to the power amplification in the digital power amplifier and supplies to the actuator as the drive signal; and
a modulation signal correcting part that corrects the modulation signal in accordance with power supply voltage to the digital power amplifier.

7. The printing apparatus according to claim 6, wherein the modulation signal correcting part comprises:
a power supply voltage detecting part that detects the power supply voltage to the digital power amplifier; and
a drive waveform signal correcting part that corrects the drive waveform signal generated in the drive waveform signal generating circuit, based on the power supply voltage detected in the power supply voltage detecting part.

8. The printing apparatus according to claim 6, wherein the modulation signal correcting part comprises:
a power supply voltage detecting part that detects the power supply voltage to the digital power amplifier; and
a triangular wave signal correcting part that corrects an oscillation of triangular wave signal for the pulse modulation, based on the power supply voltage detected in the power supply voltage detecting part.

9. The printing apparatus according to claim 6, wherein the modulation signal correcting part comprises:
a variable power supply voltage calculating part that calculates variable power supply voltage to the digital power amplifier, based on the number of actuators to be driven; and
a drive waveform signal correcting part that corrects the drive waveform signal generated in the drive waveform signal generating circuit, based on the variable power supply voltage calculated in the variable power supply voltage calculating part.

10. The printing apparatus according to claim 6, wherein the modulation signal correcting part comprises:
a variable power supply voltage calculating part that calculates variable power supply voltage to the digital power amplifier, based on the number of actuators to be driven; and
a triangular wave signal correcting part that corrects an oscillation of triangular wave signal for the pulse modulation, based on the variable power supply voltage calculated in the variable power supply voltage calculating part.
